(19) United States
(12) Patent Application Publication
(10) Pub. No.: US 2021/0148706 A1
(43) Pub. Date: May 20, 2021

(54) AQUISITION PROCESS OF AT LEAST ONE SCENE

(71) Applicant: SOLETANCHE FREYSSINET, Rueil-Malmaison (FR)

(72) Inventors: José Peral, Moirans (FR); Pierre Francois, Rueil-Malmaison (FR); Gilles Hovhanessian, Antony (FR)

(21) Appl. No.: 16/951,429

(22) Filed: Nov. 18, 2020

(30) Foreign Application Priority Data
Nov. 18, 2019 (FR) 19 12851

(51) Int. Cl. G01C 11/02; G06T 7/521; G06T 7/55; G06K 9/62; G06K 9/20; G06T 7/73; G01C 11/04

(52) U.S. Cl. CPC G01C 11/025; G06T 7/521; G06T 7/55; G06K 9/6288; G06T 2207/10028; G06T 7/74; G01C 11/04; G06T 2207/30184; G06K 9/2063

(57) ABSTRACT

A method for acquiring at least one scene, the method including a) positioning at least three different targets at different target locations of the scene, b) taking digital images of the scene and the target by means of an imaging device comprising at least one camera, the image-taking locations being chosen such that at least two of the images intersect, and c) scanning the scene and the targets by means of an optical remote detection device, each target including: a characteristic pattern identifiable by digital analysis of the scan data, called “pattern to be scanned”, and a characteristic pattern identifiable by photogrammetry, called “photogrammetric pattern”.

### TECHNICAL FIELD

The present invention relates to a method for acquiring at least one scene, notably urban, for generating a georeferenced 3D digital model representing the scene.

### PRIOR ART

The georeferenced digital models, that notably represent scenes of an urban setting, provide assistance in architectural design and in urban and territorial development.

It is known practice to construct a 3D digital model from a points cloud, previously acquired by photogrammetry or by lasergrammetry. To georeference such a model, targets are generally disposed in at least one of the scenes to be acquired, the position of the target being itself measured accurately within a given reference frame. Such an acquisition is for example known from EP 2 018 515 B1.

In order to georeference the targets, it is known practice to involve a land surveyor who can use a theodolite, a tacheometer, a total station or a GNSS system, which is complex and time-consuming to implement. Furthermore, the targets have to be geolocated again on each intervention in the scene, which increases the complexity of acquisition.

It is also known practice to use satellite positioning systems to georeference the targets. Like the preceding technique, the georeferencing by satellite requires the targets to be geolocated in situ on each intervention, and as many times as there are targets.

Furthermore, to generate a 3D digital model representing an urban setting with accuracy, for example a town occupying a surface area of several square kilometers, sets of independent scene acquisitions can be produced, each set comprising, for example, acquisitions of scenes in several adjacent streets. More than 50 targets per square kilometer may then be necessary to georeference the model, which demands numerous interventions from the land surveyor.

There is consequently a need to simplify the georeferencing of a 3D digital model of a scene, notably generated by photogrammetry, in particular by limiting intervention of a qualified operator, such as a land surveyor.

There is also an interest in georeferencing a 3D digital model of an underground installation, preferably in an absolute reference frame, in order to facilitate interventions in this underground installation, which is, for example, a sewage network.

### SUMMARY OF THE INVENTION

The invention aims to address this need and its subject is a method for acquiring at least one scene, the method comprising:

a) positioning at least three different targets at different target locations of the scene,
b) taking digital images of the scene and of the targets by means of an imaging device comprising at least one camera, the image-taking locations being chosen such that at least two of the images intersect, and
c) scanning the scene and the targets by means of an optical remote detection device, preferably by means of a lidar, each target comprising:
a characteristic pattern identifiable by digital analysis of the scan data, called “pattern to be scanned”, and
a characteristic pattern identifiable by photogrammetry, called “photogrammetric pattern”.

The implementation of the method according to the invention facilitates the georeferencing of a 3D digital model of the scene, notably obtained by photogrammetry. Advantageously, the 3D digital model can be scaled and optionally georeferenced without the intervention of a land surveyor in the implementation of the acquisition method for georeferencing the targets.

Moreover, the implementation of steps b) of image-taking and c) of scan is simplified, the same targets being imaged and scanned respectively. Finally, a possible correlation of a digital model obtained from the images and of a digital model generated from the scan is facilitated, the patterns of the targets defining the common spatial references.

The scene is preferably an outside urban zone, comprising, for example, buildings such as collective residential blocks or offices, individual houses, street furniture such as lamp posts, road signs, advertising signs, shelters or benches, among others.

The scene may comprise an interior of a building, for example a network of corridors and of rooms.

The scene may comprise an overhead part and/or an underground part, for example a sewage network.

The scene may extend over an area, projected onto the ground, greater than 1.0 m², even greater than 2.0 m², even greater than 10 m², even greater than 1 km², even greater than 10 km², even greater than 50 km², even greater than 100 km².

The scene may comprise at least one mechanical part or a construction, for example a building or a civil engineering structure, or an element of a construction, for example a pipeline.

The civil engineering structure may be chosen from among a bridge, a tunnel, notably road or rail, a sewage network, a road and a street.

In particular, the scene may contain at least one manhole of a sewage network which emerges on the surface.

In step a), the targets may be presented at various target locations of the scene. The target locations are different, and preferably distant, from one another.

The targets are, for example, fixed onto objects of the scene, notably onto a wall of a building or onto a street furniture element or onto a sign post, or placed on the ground.

The targets may be disposed in the overhead part and/or in the underground part of the scene.

The targets may all be disposed in the overhead part or in the underground part.

When the scene comprises a manhole, one of the targets can be positioned in the manhole and at least one of the other targets can be positioned in the overhead part, for example at least 50 m, even less than 10 m, even less than 5 m, even less than 1 m from the manhole.

The number of targets and/or the density of targets may vary according to the extent of the scene. In particular, the number of targets may increase with the extent on the ground of the scene.

Thus, in step a), it is possible to position more than five targets, even more than ten targets.

“Ground density of targets on the ground” is understood to mean the ratio of the number of targets to the area of the scene projected vertically onto the ground.

For example, the extent equipped with the targets may cover all of a street, even better all of a district, even a plurality of districts.

At least one, even each, of the targets can take the form of a plate, of a sheet or of an adhesive label.

Each target may have a length ranging between 100 mm and 840 mm and/or a width ranging between 150 mm and 1200 mm. For example, each target can have a size of between an A6 sheet size and an AO sheet size.

Each target comprises a photogrammetric pattern identifiable by photogrammetric processing.

Preferably, at least one of the targets, preferably each target, comprises a support, the photogrammetric pattern being applied to the support.

The photogrammetric pattern may be painted, glued or etched, or preferably printed on the support.

The photogrammetric pattern may be an adhesive label glued onto the support.

The photogrammetric pattern may be coded.

The coded photogrammetric pattern may show an identifier recognizable by photogrammetry, the identifier being associated with the target. The identifier may be an alphanumeric symbol or a series of such symbols. The photogrammetric processing of one or more coded photogrammetric patterns may result in the generation of the identifier and in particular in the assignment of the identifier to the coded pattern and to the target. Each target can comprise a unique identifier which is specific to it.

The coded photogrammetric pattern is, for example, a barcode or a matrix code, notably a QR code.

Alternatively, the photogrammetric pattern may be non-coded. An example of non-coded photogrammetric pattern is a complete circle or a geometric figure with four segments.

The photogrammetric pattern may take several forms. Preferably, the outline of the photogrammetric pattern is circular, the position of the center of the photogrammetric pattern thus remains unchanged by rotation or by change of scale.

Preferably, to facilitate, and notably automate, the photogrammetric processing, the photogrammetric pattern of one of the targets is different from the photogrammetric pattern of at least one of the other targets, and preferably the targets comprise the same pattern to be scanned. The production of the targets is thus simplified.

The surface area covered by the pattern to be scanned and by the photogrammetric pattern may represent more than 30%, better still more than 50%, even more than 70% of the total surface area of the support.

The surface area covered by the pattern to be scanned may represent more than 30%, better still more than 50%, even more than 70% of the surface area covered both by the pattern to be scanned and the photogrammetric pattern.

The pattern to be scanned is preferably applied to the support.

For example, the pattern to be scanned is painted, glued or etched, or preferably printed on the support.

The pattern to be scanned is preferably non-coded. The pattern to be scanned can exhibit a sufficient contrast with the support to be recognized by the scan analysis method. The pattern to be scanned can be in the form of a chequerboard, for example in black and white, or in the form of a ring.

The pattern to be scanned may be black and disposed on a white support.

The photogrammetric pattern may be disposed at the center of each target.

The pattern to be scanned may at least partially, even completely, surround the photogrammetric pattern.

The photogrammetric pattern may comprise a central portion defining the center of the target and the pattern to be scanned can be centered with respect to the center of the target. The referencing of the positions of the photogrammetric data by means of the scan data can thus be facilitated.

The central portion may be defined by internal and external outlines sharing the same barycenter, which forms the center of the target.

The internal and external outlines may be homothetic to one another.

The internal and external outlines may delimit a surface having a different color from the surface delimited by the internal outline. For example, the surface defined between the internal and external outlines of the central portion is a ring of black color and the surface defined inside the internal outline is a disk of white color.

The pattern to be scanned may comprise first and second parts each having an outline comprising two segments, the straight lines supporting the segments intersecting at the center of the target. One of the segments of the first part and one of the segments of the second part can be supported by the same straight line passing through the center of the target.

Preferably, at least one other of the segments of the first part and at least one other of the segments of the second part are supported by the same other straight line which passes through the center of the target.

Preferably, the first part of the pattern to be scanned is symmetrical to the second part of the pattern to be scanned with respect to the center of the target.

The support may be made of cardboard, paper, wood, or preferably of a thermoplastic. A support made of thermoplastic is preferred, because it does not degrade under the effect of humidity.

The support is preferably rigid. It preferably has the form of a flat plate.

The support may be covered with an adhesive material.

The support may be painted, notably white.

The target may comprise a stick provided, at one of its ends, with a foot, for example a tripod, to keep it standing on the ground and the support can be mounted on its opposite end.

The support may have an outline, when seen from the front, of generally circular, elliptical or polygonal form, notably triangular, rectangular or square.

The support may have a length comprised between 100 mm and 840 mm and/or a width comprised between 150 mm and 1200 mm. For example, it has a size of between an A6 sheet size and an AO sheet size.

Preferably, the step b) comprises taking images at at least five image-taking locations, better still at at least 10 image-taking locations, even better at at least 100 image-taking locations.

The step b) may comprise taking several digital images at the same image-taking location, preferably from different points of view.

The image-taking locations may be chosen such that each of the targets disposed in the step a) is visible on at least one of the images taken in the step b).

Preferably, the image-taking locations are chosen so that at least two images represent the same target to improve the quality of the photogrammetric processing.

The image-taking locations may be chosen such that at least two different targets are represented on the same image of the set.

The image-taking locations may be situated in an overhead part and/or an underground part of the scene.

The step b) may comprise moving of the imaging device along an open path or a closed path.

“Closed path” is understood to mean a path in which the point of departure and the point of arrival coincide. By contrast, an “open path” comprises a point of departure that is different from the point of arrival.

The path may comprise more than 10 image-taking locations, preferably more than 100 image-taking locations, even better more than 1000 image-taking locations.

The movement of the imaging device can be ensured by the movement, notably walking, of a human operator manipulating the imaging device. Alternatively, the imaging device may be moved by means of a vehicle, for example a car, or a flying apparatus, for example a drone, or a lifting machine, for example a crane or a winch, on which the imaging device is mounted.

The imaging device may comprise a stick and at least one image-taking level, preferably at least two image-taking levels disposed at different heights on the stick, each image-taking level comprising a plurality of cameras configured to each acquire an image of the scene, the viewing axes of the cameras of an acquisition level being distributed angularly about the axis of the stick such that the images taken by the image-taking device overlap angularly.

The stick may be adapted to be carried by an operator moving around within the scene. It can comprise, in the bottom part, a foot allowing it to be placed on the ground. The imaging device can comprise at least three, preferably three image-taking levels, the cameras of each level being distributed about the longitudinal axis of the stick, over a total angular segment of between 90° and 120°, preferably of between 150° and 190°, in particular equal to 180°. The spacing between the image-taking levels can be adjustable. The cameras of one image-taking level are preferably fixed with respect to one another. The imaging device may comprise at least six, preferably at least ten, preferably at least twelve, preferably fifteen cameras.

An example of a suitable imaging device is described in the application FR 1856591.

The images taken in step b) may be processed to generate points clouds by photogrammetry, as will be detailed later.

At the end of step c), it is possible to obtain a cloud of scanned points. The cloud of scanned points can be provided with. a metric. Thus, such a cloud of scanned points allows the real distance to be measured between points of said cloud, to within the measurement precision.

In step c), the optical remote detection device is preferably a lidar.

The optical remote detection device is different from an optical tracking device. Notably, it is different from a “laser tracker”.

An optical tracking device may notably emit a light beam, for example a laser beam, to a target which reflects the light beam to the optical tracking device, allowing the optical tracking device to then specifically track the target when the target is moving.

In an exemplary implementation of the invention, in step c) the scan of the scene and of the targets is performed with at least one rotation of the remote detection device on itself about an axis of rotation, preferably fixed during this rotation, or using several sensors having different lines of sight.

Alternatively, the scan of the scene may be performed with the remote detection device in motion during said scan.

The remote detection device may be mounted on a vehicle, for example a car.

The remote detection device can be carried by a flying apparatus, for example an airplane, a helicopter or a drone.

As a variant, the remote detection device can be mounted on a foot.

The image-taking step b) can be performed before the scan step c), or after the step c), or simultaneously with the step c).

Steps b) and/or c) may be performed by a human operator.

The acquisition method may be implemented to acquire a plurality of scenes. The targets disposed in a first of the scenes are preferably all different from the targets disposed in the other scenes.

The method may comprise a step subsequent to step b) and/or to step c) of processing of the images and/or of the scan respectively.

The acquisition method preferably comprises generating of a points cloud by digital analysis of the scan data, called “cloud of scanned points”. The processing of the data from the scan is, for example, implemented by means of the RealWorks® software published by the company Trimble®.

The method preferably comprises generating of a points cloud, called “cloud of photogrammetric points”, by photogrammetric processing of the images acquired in step b).

The photogrammetric processing may implement a conventional image correlation algorithm which identifies constituent elements of a scene on different images taken in the step b) on different viewing axes, then determines the relative positions of said constituent elements. For example, the photogrammetric processing is implemented by means of the Metashape® software published by the company Agisoft®.

Preferably, the clouds of scanned and photogrammetric points each comprise the coordinates of at least one characteristic point, for example the center of each target in respective reference markers.

Preferably, the clouds of scanned and photogrammetric points are stored digitally, notably on a computer storage means.

A computer storage means is a digital storage medium such as a magnetic strip, an optical disk, a hard disk, an SSD disk, an SD card or a USB key.

Advantageously, a metadatum relating to the target is assigned to the points of the stored targets, for example to the centers of the targets. The metadatum can correspond to an identifier of the target, as for example recognized by reading the photogrammetric pattern which is coded, as described above.

The method may comprise a step, subsequent to steps a) and c), of georeferencing of the characteristic points of the targets in the reference marker linked to the cloud of scanned points, notably in a given reference frame, for example an absolute reference frame.

“Absolute reference frame” designates a geodesic reference frame in which the location of an object on land can be defined unequivocally. Its center is for example close to the barycenter of the Earth, its first two axes are in the plane of the equator and its third axis is close to the axis of rotation of the Earth. The absolute reference frame that can be used in the context of the present invention is preferably chosen from among the following: Réseau Géodésique Français 1993 (RGF93), World Geodetic System (WGS84), International Terrestrial Rotational Service (ITRS) or European Terrestrial Reference System (ETRS).

The method may thus comprise a step of georeferencing of the cloud of scanned points, notably in a global reference frame, for example an absolute reference frame, in particular by advantageously using the georeferenced coordinates of the characteristic points of the targets.

Preferably, the cloud of scanned points is georeferenced by correlating the cloud of scanned points with another cloud of points representing at least the scene and which is georeferenced, for example by means of topographic reference markers, or with positions of points measured by means of topographic reference markers.

The other points could may have a lower resolution than the cloud of scanned points. The other points could may have a resolution less than 25 points per square meter, better still 10 points per square meter.

The correlation of the cloud of scanned points with the other points cloud, notably formed by scanned points, may result initially in the georeferencing of the coordinates of the characteristic points of the targets. The method thus dispenses with the step of georeferencing of the targets by the intervention of a qualified operator, notably a land surveyor, in the taking of the images.

The other georeferenced points cloud may be obtained by digital analysis of data originating from a terrestrial or overhead scan, for example with a lidar. For example, the other georeferenced points cloud is a cloud of scanned points obtained by lasergrammetry. Alternatively, the other georeferenced points cloud can be obtained by photogrammetry.

The other georeferenced points cloud preferably represents a more extensive zone than the scene. For example, the cloud of scanned points represents a set of streets and buildings of a town and the other cloud of points represents a district of the town containing said set, or the town.

Advantageously, it is possible to use a qualified operator such as a land surveyor only in the georeferencing of the other model, and the georeferencing by correlation of the cloud of points as described above can thus be performed without the aid of the operator. Moreover, advantageously, the other cloud of points can define a reference frame for correlating several clouds of scanned points of different scenes which are each obtained by the method according to the invention.

The method may comprise scaling the cloud of photogrammetric points from the cloud of scanned points, the scaling factor being determined from the coordinates of the characteristic points of at least two, even at least three, of the targets in the respective reference markers linked to said clouds of scanned and photogrammetric points.

The method may comprise georeferencing the cloud of photogrammetric points, notably in a global reference frame by means of the targets georeferenced by means of the cloud of scanned points, notably by correlation with the other cloud of scanned points, as described above. Thus, the scaling and georeferencing of the cloud of photogrammetric points are advantageously performed in a single step.

Another subject of the invention is a method for constructing a 3D model, the method comprising:

i) implementing the method for acquiring at least one scene according to the invention and e taking of images of at least one other scene, as implemented according to step b) of the method, the scene and the other scene sharing common elements, the other scene being notably free of targets,
ii) generating a cloud of photogrammetric points representing the scene and the other scene, and
iii) generation a 3D mesh of the scene and of the other scene, from said cloud of photogrammetric points, and optionally texturing the 3D mesh to assign a color to the elements of the 3D mesh, in particular from images acquired in step i).

### BRIEF DESCRIPTION OF THE DRAWINGS

The invention will be able to be better understood on reading the following detailed description of nonlimiting examples of implementation thereof, and on studying the attached drawing, in which:

FIG. 1 is a block diagram illustrating an example of acquisition method according to the invention,

FIG. 2a represents an example of target implemented for the method according to the invention,

FIG. 2b represents a variant target implemented for the method according to the invention,

FIG. 3 is a schematic and partial view of a scene,

FIG. 4a is a schematic and partial view of a cloud of scanned points,

FIG. 4b is a view of another cloud of scanned points,

FIG. 5 illustrates an example of correlation between two clouds of scanned points,

FIG. 6 illustrates the extraction of coordinates of the targets according to the invention,

FIG. 7 represents, in isolation, another part of the scene of FIG. 3,

FIG. 8 represents an example of imaging device, and

FIG. 9 illustrates an example of remote detection device.

### DETAILED DESCRIPTION

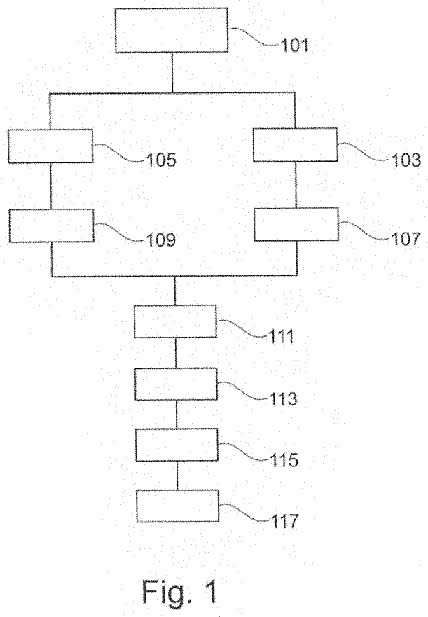

FIG. 1 illustrates an exemplary implementation of the method for acquiring a scene 5 according to the invention.

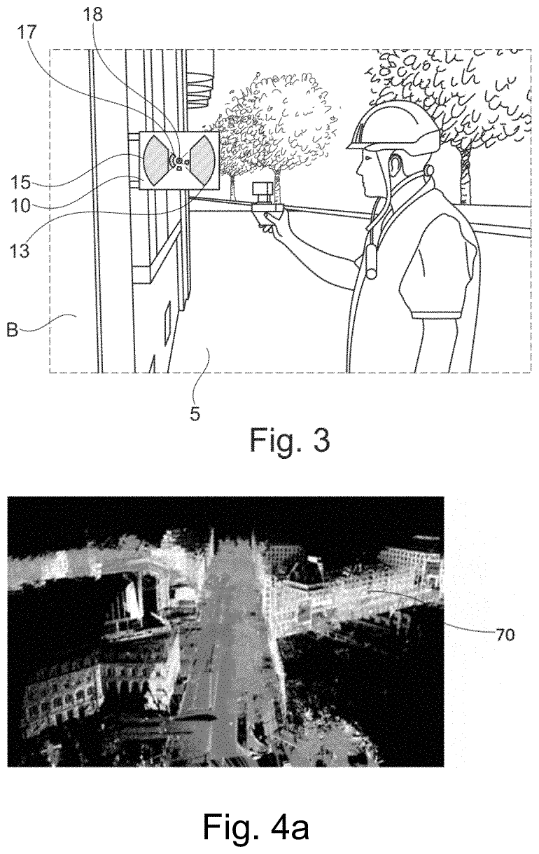

In the example of FIG. 3, the scene 5 is a district of a town comprising several streets with buildings B.

The first step is to dispose, in the step 101, in the scene 5, a plurality of targets 10. The scene can contain a manhole 30 of a sewage network which emerges on the surface. At least one of the targets 10 can be disposed in the manhole 30 as illustrated in FIG. 7.

The other targets can be fixed at target locations, for example on the wall of one of the buildings, or on a street furniture element or on a sign post, as is illustrated in FIG. 3. At this stage, the georeferencing of the targets 10 by means of a suitable appliance such a theodolite, is optional.

At least three targets, even more than three targets, better still more than five targets, even more than ten targets, can be disposed in the scene.

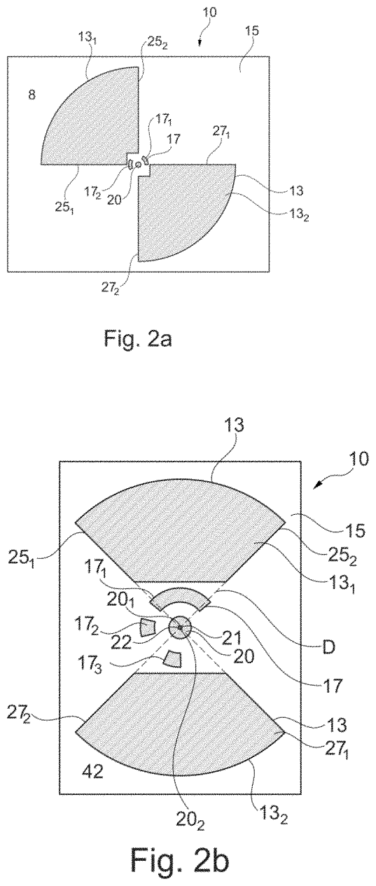

As illustrated in FIGS. 2a and 2b, each target 10 comprises a support 15, a characteristic pattern identifiable by digital analysis of the scan data 13, called “pattern to be scanned”, and a characteristic pattern identifiable by photogrammetry 17, called “photogrammetric pattern”.

The support can, as illustrated, be a rigid sheet, for example of thermoplastic, of A4 format.

The pattern to be scanned and photogrammetric pattern are applied to the support. In the example illustrated, they are printed on the support. Other application methods can be envisaged. For example, they can be glued or painted.

In the examples illustrated, the target 10 takes the form of a plate. Such a form is however not limiting. Other forms can be envisaged.

In the examples illustrated, the photogrammetric pattern 17 is coded. It comprises black annular portions 17₁₋₃ extending about a central axis X normal to the support.

The photogrammetric pattern 17 also comprises a central portion 20 defining the center of the target 21.

As illustrated in FIGS. 2a-b, the central portion 20 is defined by two outlines 20₁₋₂ that are homothetic to one another which form a pierced central disk 22, of black color, whose center is the center of the target 21.

In the example of FIGS. 2a and 2b, the photogrammetric pattern 17 is situated at the center of the target 10 and the pattern to be scanned 13 surrounds the photogrammetric pattern, two parts of the pattern to be scanned 13₁₋₂ being disposed on either side of the photogrammetric pattern.

The part of the pattern to be scanned 13₁ has an outline comprising two segments 25₁₋₂ which are supported by straight lines which intersect at the center of the target. Similarly, the part 13₂ has an outline comprising two segments 27₁₋₂.

In the examples illustrated, the segments 25₁ and 27₁ are supported by the same straight line D1, and the segments 25₂ and 27₂ are supported by the same straight line D2.

The straight lines D1 and D2 intersect at the center of the target 21.

Thus, the parts 13₁ and 13₂ are symmetrical with respect to the center of the target. Moreover, the pattern to be scanned and the photogrammetric pattern are centered on the same characteristic point which is the center of the target, which facilitates the processing of the photogrammetric data and of the scan data which are acquired using the targets.

Preferably, the photogrammetric pattern 17 of one of the targets 10 disposed in the scene 5 is different from the photogrammetric pattern of at least one of the other targets of the scene. The photogrammetric pattern can have a variable number of annular portions 17₁₋₃ between at least two targets, as illustrated in FIGS. 2a-b.

Once the targets 10 are disposed in the scene 5, the steps 103 of taking of images of the scene by means of an imaging device and of scanning 105 of the scene are implemented.

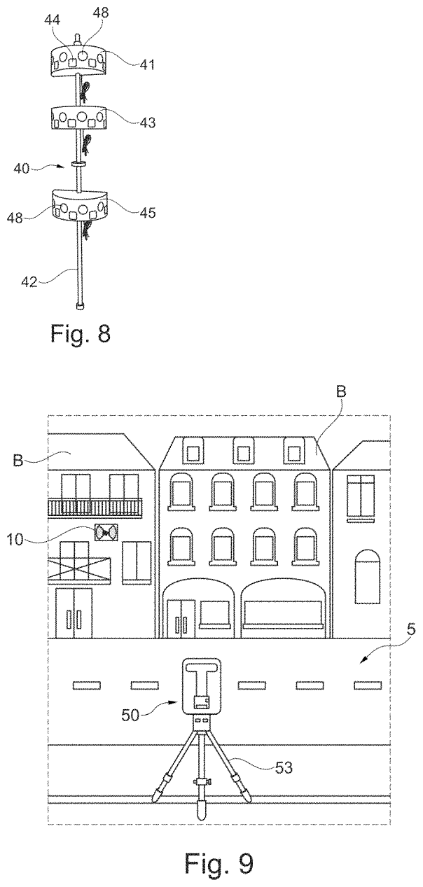

In the step 103, an imaging device 40 comprising a plurality of cameras 44 is disposed in the scene at a plurality of image-taking locations, as illustrated in FIG. 8. The cameras 44 can take at least one image of the scene at each image-taking location. The image-taking locations are chosen such that the images taken at at least two image-taking locations overlap. In the example illustrated, the imaging device 40 comprises a stick 12 of longitudinal axis X and three image-taking levels 41, 43, 45 each comprising cameras 44 and lamps 48 for lighting the scene. The cameras of each level are distributed angularly about the axis X over a total angular segment of angle equal to 180°, so as to broadly cover the scene to be imaged.

The stick has a foot 42 at its bottom end, intended to enter into contact with the ground.

In the step 105, an optical remote detection device 50 is also disposed in the scene 5 to perform the scan of the scene 5 and of the targets 10, as illustrated in FIG. 9.

The remote detection device 50 is, for example, a lidar which comprises a static base 53 and a scan head 55 that is rotationally mobile about the base. For example, the scan of the scene 5 is performed with at least one rotation of the scan head 55 on itself about an axis of rotation that remains fixed during the rotation.

As a variant, the remote detection device 50 is mobile during the scan of the scene 5.

Subsequently, the images acquired in the step 103 and the data of the scan obtained in the step 105 are analyzed digitally, by means of a computer, by photogrammetric processing 107 and by processing of the scan data 109, in order to generate clouds of photogrammetric and scanned points, respectively.

The clouds of scanned and photogrammetric points that are thus generated each comprise the coordinates of at least one characteristic point, for example the center 18, of each target 10.

Preferably, the clouds of scanned and photogrammetric points are stored digitally, notably on a computer storage means, such as an optical disk, a hard disk, an SSD disk, an SD card or a USB key.

Advantageously, a metadatum relating to the target is assigned to the points of the stored targets, for example the centers of the targets. The metadatum can correspond to an identifier of the target, for example recognized by reading of the photogrammetric pattern which is a QR code.

As described above, the targets 10 do not need to have been georeferenced prior to the taking of the images and the scan of the scene. The invention, by dispensing with the step of georeferencing of the targets 10 in the acquisition, can thus contribute to reducing the time spent in acquiring the scene.

The georeferencing of the targets 10 can be obtained after the generation of the clouds of points.

In order to georeference the targets 10, the cloud of scanned points 60 can be correlated 111 with another cloud of points 70 representing a more extensive zone that the scene 5 and which is itself georeferenced. An example of graphic result of correlation of the clouds of points is illustrated by FIG. 5.

The correlation of the clouds of points can be performed by a mathematical method which seeks to minimize the distance between the two clouds representing the same part of the scene. Regression and/or convex optimization methods can be employed for the realignment of the points clouds scanned on the other cloud of points.

The other cloud of points 70 is for example georeferenced by means of topographic reference markers, or with positions of points measured by means of topographic reference markers.

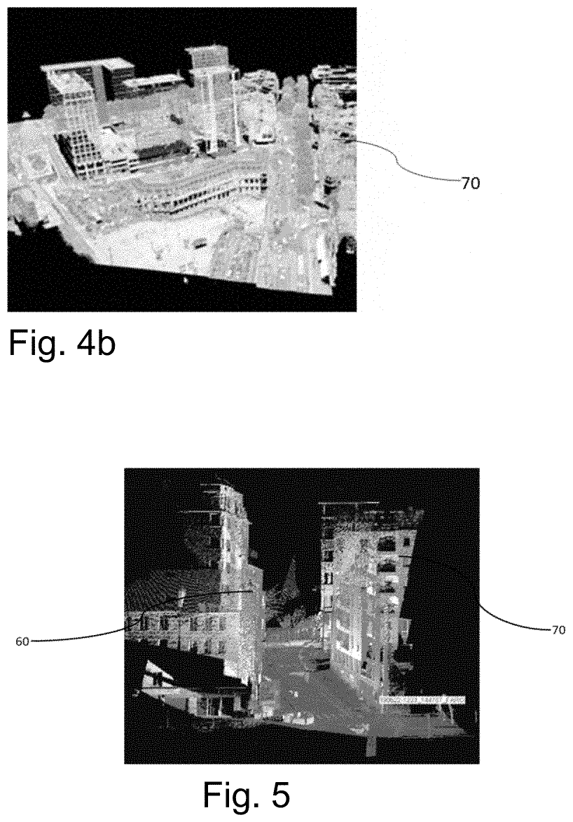

The other georeferenced cloud of points can be obtained by digital analysis of data originating from a scan performed, for example by means of a lidar installed in a motor vehicle, as illustrated in FIG. 4a, or in an airplane, a helicopter or a drone, as illustrated in FIG. 4b.

In the examples illustrated, the other georeferenced cloud of points 70 is a cloud of scanned points obtained by lasergrammetry.

After correlation, the cloud of scanned points 60, obtained by processing of the scan of the scene 5 in the step 109, is thus georeferenced in the step 111.

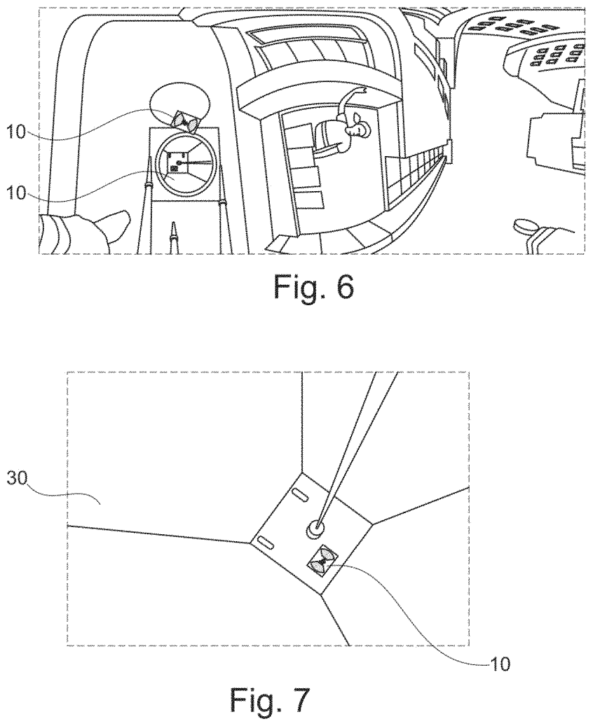

In the step 113, the georeferenced coordinates of the characteristic points of the targets 10 can thus be extracted, as illustrated by FIG. 6.

The position of the targets 10 being known in the cloud of scanned points and in the cloud of photogrammetric points, the cloud of photogrammetric points can then be georeferenced in turn and scaled, in the step 115. The scale factor is determined from the coordinates of the characteristic points of at least two, even at least three, of the targets in the respective reference markers linked to said clouds of scanned and photogrammetric points.

The georeferenced and scaled cloud of photogrammetric points can be used to construct a 3D digital model of the scene, which can be meshed and textured.

Obviously, the invention is not limited to the examples illustrated.

1. A method for acquiring at least one scene, the method comprising
a) positioning at least three different targets at different target locations of the scene,
b) taking digital images of the scene and the targets by means of an imaging device comprising at least one camera, the image-taking locations being chosen such that at least two of the images intersect, and
c) scanning the scene and the targets by means of an optical remote detection device, each target comprising:
a characteristic pattern identifiable by digital analysis of the scan data, called “pattern to be scanned”, and
a characteristic pattern identifiable by photogrammetry, called “photogrammetric pattern”.

2. The method according to claim 1, comprising generating of a points cloud by digital analysis of the scan data, called “cloud of scanned points”, and of a points cloud by photogrammetry, called “cloud of photogrammetric points”.

3. The method according to claim 2, the clouds of scanned and photogrammetric points each comprising the coordinates of at least one characteristic point of each target in respective reference markers.

4. The method according to claim 1, step b) being performed before step c), or after step c), or simultaneously with step c).

5. The method according to claim 1, the optical remote detection device being a lidar.

6. The method according to claim 1, at least one of the targets comprising a support, the photogrammetric pattern being applied to the support.

7. The method according to claim 1, the pattern to be scanned surrounding, at least partially, the photogrammetric pattern.

8. The method according to claim 1, the photogrammetric pattern comprising a central portion defining the center of the target and the pattern to be scanned being centered with respect to said center of the target.

9. The method according to claim 1, the photogrammetric pattern of one of the targets being different from the photogrammetric pattern of at least one of the other targets.

10. The method according claim 9, the targets further comprising the same pattern to be scanned.

11. The method according to claim 2, comprising the georeferencing of the cloud of scanned points.

12. The method according to claim 11, the cloud of scanned points being georeferenced by correlating the cloud of scanned points with another cloud of scanned points representing at least the scene and which is georeferenced or with positions of points measured by means of topographic reference markers.

13. The method according to claim 12, the other georeferenced cloud of scanned points representing a more extensive zone than the scene.

14. The method as claimed in claim 2, comprising the scaling of the cloud of photogrammetric points from the cloud of scanned points, the scaling factor being determined from the coordinates of the characteristic points of at least two of the targets in the respective reference markers linked to said clouds of scanned and photogrammetric points.

15. The method according to claim 14, comprising the georeferencing of the cloud of photogrammetric points.

16. The method according to claim 1, the scene comprising at least one mechanical part, or a construction or a construction element, for example a pipeline.

17. The method according to claim 1, wherein the scene contains a manhole of a sewer network which emerges on the surface, at least one of the targets being disposed in the manhole and at least one other of the targets being disposed on the surface.

18. The method according to claim 17, the or the other targets being fixed onto a wall of a building or onto a street furniture element or onto a sign post.
